(19) United States
(12) Patent Application Publication
(10) Pub. No.: US 2008/0042368 A1
(43) Pub. Date: Feb. 21, 2008

(54) Piston ring assembly including a self accommodating smart piston ring

(75) Inventor: Asim Tewari, Bangalore (IN)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/462,730

(22) Filed: Aug. 7, 2006

(51) Int. Cl. F16J 9/00

(52) U.S. Cl. 277/434

(57) ABSTRACT

A piston ring assembly includes a piston ring formed of a shape memory alloy. By using a shape memory alloy material, the piston ring changes its shape during exposure to transient thermal conditions so as to minimize engine wear. The shape memory alloy composition of the piston ring is selected to exhibit a martensite phase during cold start operating conditions and as the temperature increases changes to the austenite phase so as to recover its original shape.

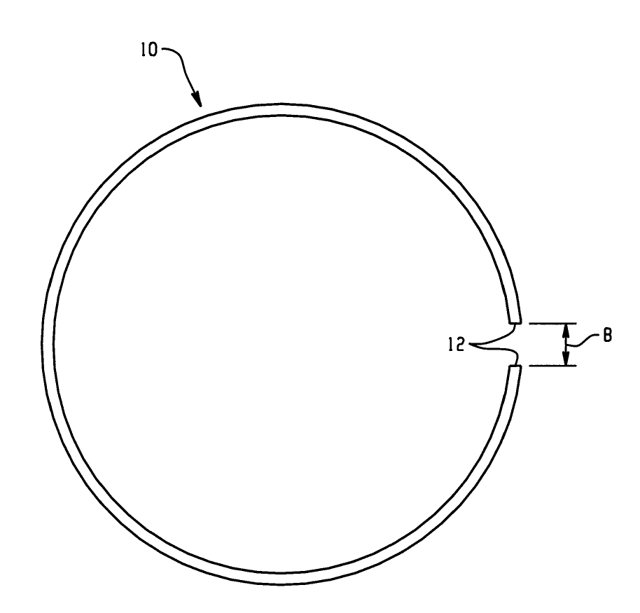

### BACKGROUND

This disclosure relates to a piston ring assembly that includes a self-accommodating smart piston ring, and more particularly, to a piston ring made of a shape memory alloy.

Piston rings are open-ended rings that generally fit into a groove on the outer diameter of a piston. Its chief functions are to form a seal between the piston and a cylinder wall as well as to provide lubrication between the piston and the cylinder wall. Current piston rings are made from various steel compositions whose hardness does not significantly change with temperature, but whose dimensions change as a function of thermal expansion.

During operation of an internal combustion engine, for example, the piston assembly and cylinder walls are exposed to transient thermal conditions until a steady state operating temperature is reached. For example, during a cold start of the engine, the temperature can be approximately the same as the environment of the engine. In cold climates, the temperature of the engine and its associated components can be anywhere from about −20° C. to about 5° C., whereas during operation, the temperature of the engine frequently exceeds 200° C. Differential thermal expansion between the piston, piston ring, and cylinder walls resulting from the transient thermal conditions can cause high radial stresses, especially since the compositions of these materials can vary. The thermally generated stresses are generated by the different coefficients of heat expansion of interconnected engine components, particularly the crank case and the cylinder head, by temperature gradients during operation as well as by the gas pressure during operation. These thermally generated stresses can affect the sealing behavior of the piston ring both during engine start (cold engine) and during operation (warm engine) as well as cause wear and erosion damage to the various components.

Accordingly, there is a need for piston assemblies that are less prone to wear and erosion during exposure to transient thermal conditions.

### BRIEF SUMMARY

Disclosed herein a piston ring assembly, a piston ring, and process for decreasing engine wear during exposure to transient thermal conditions. The piston ring assembly comprises a cylindrically shaped piston having an annular recess circumferentially disposed about the cylindrically shaped piston; and an open-ended piston ring formed of a shape memory alloy.

The process for decreasing engine wear during exposure to transient thermal conditions comprises disposing a piston ring in an annular recess about a piston in sliding engagement within a cylinder bore, the piston ring comprising a shape memory alloy, wherein the shape memory alloy exhibits a martensite phase at a cold state operating temperature; and increasing the temperature of the engine to a steady state operating temperature and changing the shape memory alloy from the martensite phase to an austenite phase.

The above described and other features are exemplified by the following FIGURE and detailed description.

### BRIEF DESCRIPTION OF THE DRAWINGS

The FIGURE illustrates a top plan view of a piston ring in accordance with the present disclosure.

### DETAILED DESCRIPTION

The present disclosure is directed to piston rings formed of a shape memory alloy that, upon exposure to transient thermal conditions, self adjusts its dimensions in an amount effective to accommodate the thermal transition conditions with sufficient control to maintain stresses below levels that could lead to excessive wear of the cylinder walls and piston ring. In one embodiment, the piston ring is adapted for use in a piston assembly employed in a cylinder of an internal combustion engine.

Shape memory alloys generally refer to a group of metallic materials that demonstrate the ability to return to some previously defined shape or size when subjected to an appropriate thermal stimulus. These alloys exist in several different temperature-dependent phases. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (As). The temperature at which this phenomenon is complete is called the austenite finish temperature (Af). When the shape memory alloy is in the austenite phase and is cooled, it begins to change into the martensite phase, and the temperature at which this phenomenon starts is referred to as the martensite start temperature (Ms). The temperature at which austenite finishes transforming to martensite is called the martensite finish temperature (Mf). Generally, the shape memory alloys are softer and more easily deformable in their martensitic phase and are harder, stiffer, and/or more rigid in the austenitic phase. In view of the foregoing properties, expansion/deformation of the shape memory alloy is preferred in its martensitic state (at or below the martensite finish temperature Mf). Subsequent heating above the austenite transition temperature causes the expanded shape memory alloy to revert back to its permanent shape.

The temperature at which the shape memory alloy remembers its high temperature form when heated can be adjusted by slight changes in the composition of the alloy and through thermo-mechanical treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. For example, the piston ring can be made from a nickel titanium shape memory alloy composition that provides an Mf of about 10° C. and an Af of about 50° C., wherein the shape of the piston ring is trained for the steady state operating temperatures.

In the example given, at temperatures at or below about 10° C. (such as may be observed during cold starts) the piston ring would be in the soft martensitic phase so as to accommodate the shape of piston within the cylinder and conform through reversible plastic deformation when the clearance tolerances within the cylinder decrease. By forming the piston ring with a shape memory alloy, the deformation within the cylinder caused by the transient thermal conditions can be accommodated. As the temperature increases, the mechanical properties of the piston ring vary greatly over the temperature range spanning their transformation, typically providing shape memory effects, superelastic effects, and high damping capacity. At some point, the steady state operating temperature is reached and the piston ring transforms to the harder austenite phase and relieves the plastic strain caused by the thermal stresses to completely recover to the shape optimized for the steady state operating temperature. In this manner, the effectiveness of the piston ring can be maintained over the transient thermal conditions.

The FIGURE depicts a top plan view of a piston ring 10 made from the shape memory alloy. The piston ring is generally circular in shape having a predefined ring gap “B”. In some applications, the ends defining the open ends 12 can have beveled edge, a tapered profile, or any other shape as may be desired. During a cold start of the engine, the differential thermal expansion of the cylinder wall and the piston would cause the piston ring to expand faster than the cylinder, which causes the ring gap “B” to completely close and create compressive stresses between the ring face and the cylinder wall. This condition causes very high friction that could lead to high wear of the cylinder wall at the major thrust face. However, when the ring is made of the shape memory alloy, the piston ring is in its softer martensitic condition at the low temperature environment and will incur recoverable plastic deformation to accommodate any excessive circumferential or radial stresses caused by the cylinder wall.

When the engine heats up after a few firing cycles, the land clearance returns to its initial designed gap, and the ring material also transforms to the harder austenite phase at which point any plastic strain and ring shape is fully recovered. The piston ring, formed of the shape memory alloy, can be tailored to optimize the amount and temperature of transformation between the austenite and martensite phases to virtually eliminate any engine wear due to radial and circumferential stresses during temperature transitions. In another embodiment, the final shape of the rings can also be so designed such that the optimum ring gap during steady state operation minimizes blow-by.

Also, it is noted that the pseudo super elastic nature of shape memory alloys will allow the piston ring 10 to conform perfectly to the piston and cylinder liner to provide an excellent seal.

Suitable shape memory alloy materials include, but are not intended to be limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order so long as the alloy composition exhibits a shape memory effect, e.g., change in shape orientation, changes in yield strength, and/or flexural modulus properties, damping capacity, superelasticity, and the like. Selection of a suitable shape memory alloy composition depends on the temperature range where the component will operate.

Shape setting or training of the piston ring depends on the particular shape memory alloy material. Shape setting may include constraining the piston ring on a mandrel or fixture to the desired shape and applying an appropriate heat treatment. The shape can also be imparted by surface treatments such as application of high-energy beams from ion or laser sources or other mechanical means such as by shot peening or polishing. The heat treatment methods used to set the shape in both shape memory and superelastic forms of the shape memory alloy are similar. The heat treatment parameters chosen to set both the shape and the properties of the piston ring usually need to be determined experimentally. For example, shape setting nickel titanium shape memory alloys generally requires a temperature greater than about 400° C. for a period of time greater than about 1 minute. Rapid cooling of some form is preferred via a water quench or rapid air cool. Higher heat treatment times and temperatures will increase the actuation temperature of the part and often give a sharper thermal response. Alternatively, if intrinsic two-way operation is desired, the shape memory alloy may be cooled below M_{f} and bent to a desired piston ring shape. The piston ring is then heated to a temperature above A_{f} and allowed freely to take its austenite shape. The procedure is repeated about 20 to about 30 times, which completes the training. The piston ring now assumes its programmed shape upon cooling under M_{f} and to another shape when heated above A_{f}. In another embodiment, the piston ring is bent just above Mₛ to produce the preferred variants of stress-induced martensite and then cooled below the M_{f} temperature. Upon subsequent heating above the A_{f} temperature, the piston ring takes its original austenitic shape. This procedure is repeated about 20 to about 30 times.

Advantageously, the piston rings formed of the shape memory alloy provide, among others, less friction and lower cylinder wear upon exposure to transient thermal conditions, longer piston ring operating lifetimes, lower blow by since the piston ring would retain its dimensional specifications due to less wear and also would be self accommodating at the various temperatures defining the transient thermal conditions. In addition, it is expected that longer engine life can be obtained especially in cold starts; increased horsepower and torque occurs, again since the piston ring self adjusts at the different transient thermal conditions; and higher engine vacuum results because of the improved sealing capability. An additional benefit of this approach would be improved sealing of non-circular bores such as may be useful as in elliptical engines.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A piston ring assembly, comprising:
a cylindrically shaped piston having an annular recess circumferentially disposed about the cylindrically shaped piston; and
an open-ended piston ring formed of a shape memory alloy.

2. The piston ring assembly of claim 1, wherein the shape memory alloy comprises nickel-titanium based alloys, indium-titanium based alloys, nickel-aluminum based alloys, nickel-gallium based alloys, copper based alloys, gold-cadmium based alloys, iron-platinum based alloys, iron-palladium based alloys, silver-cadmium based alloys, indium-cadmium based alloys, manganese-copper based alloys, or combinations comprising at least one of the foregoing alloys.

3. The piston ring assembly of claim 1, wherein the piston ring comprises a shape memory alloy composition selected to exhibit an austenite phase at a steady state engine operating temperature and a martensite phase at a cold state operating temperature.

4. The piston ring assembly of claim 1, wherein the steady state operating temperature is greater than 200° C.

5. The piston ring assembly of claim 1, wherein the open-ended piston ring has a beveled edge at each one of the open ends.

6. A piston ring, comprising:
an open ended ring formed of a shape memory alloy.

7. The piston ring of claim 6, wherein the open-ended ring has a memorized shape at a steady state operating temperature of an engine.

8. The piston ring of claim 6, wherein the shape memory alloy comprises nickel-titanium based alloys, indium-titanium based alloys, nickel-aluminum based alloys, nickel-gallium based alloys, copper based alloys, gold-cadmium based alloys, iron-platinum based alloys, iron-palladium based alloys, silver-cadmium based alloys, indium-cadmium based alloys, manganese-copper based alloys, or combinations comprising at least one of the foregoing alloys.

9. The piston ring of claim 6, wherein the piston ring comprises a shape memory alloy composition selected to exhibit an austenite phase at a steady state engine operating temperature and a martensite phase at a cold state operating temperature.

10. The piston ring of claim 6, wherein the steady state operating temperature is greater than 200° C.

11. The piston ring of claim 6, wherein the open-ended piston ring has a beveled edge at each one of the open ends.

12. A process for decreasing engine wear during exposure to transient thermal conditions, the process comprising:
disposing a piston ring in an annular recess about a piston in sliding engagement within a cylinder bore, the piston ring comprising a shape memory alloy, wherein the shape memory alloy exhibits a martensite phase at a cold state operating temperature; and
increasing the temperature of the engine to a steady state operating temperature and changing the shape memory alloy from the martensite phase to an austenite phase.

13. The process of claim 12, wherein the shape memory alloy comprises nickel-titanium based alloys, indium-titanium based alloys, nickel-aluminum based alloys, nickel-gallium based alloys, copper based alloys, gold-cadmium based alloys, iron-platinum based alloys, iron-palladium based alloys, silver-cadmium based alloys, indium-cadmium based alloys, manganese-copper based alloys, or combinations comprising at least one of the foregoing alloys.

14. The process of claim 12, wherein the piston ring conforms to the bore thorough a reversible plastic deformation.

15. The process of claim 14, wherein increasing the temperature of the engine to a steady state operating temperature relieves the plastic deformation and the piston ring recovers an original shape.

16. The process of claim 12, wherein the piston ring in the martensite phase has a first shape and in the austenite phase has a second shape, wherein the first and second shapes are different.
